(19) United States
(12) Patent Application Publication
(10) Pub. No.: US 2005/0288984 A1
(43) Pub. Date: Dec. 29, 2005

(54) Outsourcing simulation system and method

(76) Inventor: Kenneth John Hamilton, Dallas, TX (US)

Correspondence Address: HOWISON & ARNOTT, L.L.P, P.O. BOX 741715, DALLAS, TX, 75374-1715, US

(21) Appl. No.: 11/109,342

(22) Filed: Apr. 19, 2005

Related U.S. Application Data
(60) Provisional application No. 60/564,040, filed on Apr. 21, 2004.

(51) Int. Cl. G06F 17/00

(52) U.S. Cl. 705/8

(57) ABSTRACT

A method for creating a relationship with an outsourcing client is disclosed. A two way service relationship is simulated between two or more legal entities. This is facilitated by providing metrics that interrelate between the two or more legal entities, and then applying known service management principles to define an improvement in the simulated relationship between the two or more legal entities and as a function of the metrics.

### CROSS-REFERENCE TO RELATED APPLICATIONS

This application claims priority to Provisional Patent Application Ser. No. 60/564,040, filed Apr. 21, 2004, which is incorporated herein by reference in its entirety.

### TECHNICAL FIELD OF THE INVENTION

This invention is related to a business simulation method, and in particular, a simulation of an outsourcing relationship.

### BACKGROUND OF THE INVENTION

The value proposition of outsourcing has only be-come more compelling in our current resource-constrained economy as business leaders seek to leverage their proven outsourcing partnerships to accomplish even more, with less.

Extending and redefining the true value proposition. The trend toward outsourcing not only in IT, but also in back-office business processes shows that corporate leaders want to extend the value gained by implementing even more outsourced services solutions.

Most would agree that in today's business environment, the question isn't whether to out source, but how to derive the greatest value from your outsourcing investment. So how do you, as a buyer of outsourcing services drive greater value for your companies? In the past, businesses felt that getting the best new technology would do it. But in today's technology environment, there is no killer app that by itself will take you to the next level of performance. Again, in the past, if a provider had a particular process expertise, that would mean value. But today, many clients also have sophisticated process domain expertise. What this all means is that the true value proposition for today has become the service relationship you have with your sourcing provider. Service has become the killer app and real value differentiator that drives client satisfaction and it isn't easy to achieve at world class satisfaction levels of 95% or higher. Recent Gartner, Inc. research cites service as the highest risk and the highest reward in any sourcing relationship. In Gartner's BPO report of Oct. 7, 2002, service is the highest-rated selection criteria, as well as the highest rated obstacle influencing outsourcing.

As business leaders move to out source a greater depth and breadth of services across their enterprises and on a global scale, providers are increasingly touching the corporate world's most valuable asset, human capital and contributing strategically to help corporations efficiently manage critical information and intellectual property.

Outsourcing is extending to more people-centered activities that invade organization at a more intimate level, where cultural match and service delivery become key to delivering on the value proposition. Just as cultural assimilation is the number one reason mergers fail, it's also the number one factor influencing the success of outsourcing relationships.

In all sourcing relationships, strategic sourcing can only achieve bottom-line impact if a company chooses a trusted partner that has clear methodologies and processes in place ones that ensure deep and consistent service results throughout the tenure of the business partnership.

To drive and extend the value of outsourcing relationships, the recipient of the outsourcing services must apply stringent performance measures. The provider of the outsourcing services must have a clearly defined service vision that aligns with the recipient's priorities and hones in on creating measurable value. The recipient should feel certain that their provider has a service methodology, infrastructure skills and technology, and metrics capabilities in place both to deliver and measure short- and long-term ROI and value-added service.

Operational excellence, product leadership and highly effective client relationship management are keys to assuring superior service delivery. The recipient's partner's service culture needs to be geared to produce high quality, reproducible, scalable and measurable results that align with their objectives. Priorities should be regularly gauged and used to define the service standard. The provider should have enterprise-wide goals that are enforced via internal service level agreements that enable service professionals to work together as a team to achieve goals and deliver on expectations.

The recipient should partner with an organization that can enhance the recipient's expertise, streamline processes, expand the recipient's knowledge base, improve service delivery, and that continuously invests in technology that supports superior service delivery. Ensure clearly defined service standards and performance measures that provide baselines from which to measure performance, determine base pricing, and report service results. Service-level standards should be aligned with these priorities in order to ensure delivery in key areas and set response times and service availability. The partner's staff should possess professional qualifications that assure superior service delivery across the organization.

Infrastructure should integrate service methodology and technology-enabled tools. Service providers should have a client care system that enables comprehensive case and document management and that is integrated with servicing tools such as interactive voice response (IVR) and telephony integration to coordinate service across the enterprise and assure efficient response times and resolution.

The recipient cannot achieve consistent results if there is no process in place to make sure that service and system capabilities continue to match the recipient's requirements over the course of a dynamically evolving service relationship. The recipient's sourcing provider should constantly touch base to a) review documented expectations and commitments; b) provide mutually agreed-upon success measures; c) conduct regularly scheduled, expert review of client-specific objectives; d) hold third-party reviews to assure candid evaluations of service performance; e) provide client relationship management and client care technology to ensure continuity of care, regardless of changes in personnel and management; and f) have clear transition management support and procedures.

Experienced relationship management should always include consulting at the executive level to review and revise service agreements so as to meet evolving corporate goals and initiatives. And support services should take into account the reality of change so that the recipient has the flexibility, scalability and assistance to manage business changes, such as merger and acquisition events.

The measure of any good service provider is the feedback they elicit from the recipient, their client. The recipient's feedback should be solicited on a regular basis to assure the organization is aligned around client priorities and delivering on expectations. Measurement of client satisfaction with the provider, while on the soft side of the metrics equation, should be structured in a way that determines not only the client's satisfaction level, but also the intensity behind that satisfaction, with examples of specific encounters or events. Further, in addition to maintaining internally established service level standards and performance metrics, regular surveys and outside evaluations can help validate service delivery. And, providers should have the flexibility to empower a team to move quickly through an organization at any time in order to make necessary changes.

It all starts and ends with people who have a special DNA. Finally, when a recipient is evaluating options, they must remember that in the sourcing world it all goes back to service delivery. And in today's sourcing environment, service means people who are the right, bright people; people who care; people who are incented, trained, certified, and who have been selected primarily because of their service orientation and their commitment to developing clients for a lifetime. What's also important is that these caring people must not be just the ones who created and sold the solutions, but those who provide service on a day-to-day basis over the life of the contract. In the end, your fundamental question becomes: Does my provider have the people who can do what it takes to make me not just satisfied with their service, but extremely satisfied? Because at this level of sourcing involvement, you and your service people are truly in a partnership mode.

While corporate executives recognized that there is significant value to gain by implementing these practices, many companies did not follow the practices consistently across their critical supplier relationships.

For many of the practices, less than 50% of respondents followed the practice consistently in their organization. For most of the practices, there is a significant gap between the percentage of respondents who indicated that they valued the practice and the percentage that followed the practice consistently. With such savings on the line, why haven't companies instituted these practices with greater consistency? When asked to identify the major barriers to implementation of these practices, respondents cited a number of factors which generally fell into five different categories.

First, many stated that time and resources are a huge constraint, particularly with recent economic developments, money, time, and personnel are limited. Second, they also cited management emphasis as a barrier as many companies have a number of initiatives to consider, and not all of them can be implemented. Third, organizational structure was cited as an issue, including complexities related to geographic dispersion and misalignment of incentives across business units and functions. Fourth, some respondents indicated that these practices are sometimes not followed because most of their supplier relationships are arm's-length or commodity relationships, driven primarily by price. Finally, some organizations responded that they lacked the appropriate processes, training, and tools to implement the practices effectively. Changing the way companies work takes time and effort. Especially when resources and time are limited, companies often focus on efforts that easily demonstrate their value (i.e., are easily measurable). Supplier consolidation, for example, promises and often produces easily quantifiable cost savings, so companies have historically focused on consolidation as a means for quickly cutting cost. The value to be gained through implementation of many of these practices is not so easily measurable, however, which sometimes leads to less management emphasis on practices such as these.

Additionally, many companies tend to focus on overly complex technical solutions to those that are difficult and costly to implement. In part, this may be because consultants in this arena are motivated not only to help clients solve problems, but also (even if only subconsciously) to sell complex solutions. Companies sometimes overlook simpler, more straightforward actions they can take to gain value without expending a huge amount of resource. Another obstacle is that, even with long-term partners, many companies are reluctant to share sensitive information to a barrier that might be termed a fundamental collaboration dilemma. To gain more value, a company must often share information with its suppliers about its interests, goals, operations, and so on, which then gives their suppliers more leverage—a supplier can use such knowledge to hold a customers interests hostage during negotiations in order to gain concessions. However, in the absence of robust information sharing, opportunities for suppliers to add value are significantly circumscribed. Similarly, more interdependent relationships with suppliers (e.g., joint planning, operations integration) bring both enhanced opportunities and increased risk.

The next wave of sustainable cost savings and increased value in sourcing will come from better negotiation with suppliers and better management of critical supplier relationships. A fundamental challenge that companies face is how to systematically institutionalize approaches and practices for: Effectively evaluating and selecting critical suppliers; Negotiating sustainable, value-maximizing deals; Working with suppliers as partners in new and interdependent ways; Effectively managing the intra- and inter-organizational complexity associated with strategic supplier relationships; Measuring and monitoring the value and performance of critical supplier relationships

Many companies are beginning to segment their supply relationships based on a number of different factors. Such variables often include: Cost or difficulty of switching suppliers; Total spend with a particular supplier; Strategic importance of the good or service being sourced; Complexity of requirements; Complexity of the supplier relationship; Number of business units or internal customers served by the supplier

A sourcing model framework is disclosed utilizing the analogy of nouns and verbs in a relationship diagram to describe verbs as functions to be performed and nouns as the devices or environments that they were performed upon. The relationship of those nouns and verbs can then be tracked as if in a sentence to elaborate on the specification of the specific service.

In a prior art example illustrated in FIG. 1, a complex service delivery matrix is illustrated, typically with a life-cycle of services listed down one axis 102 and the devices and environments (geographies, buildings, etc.) down the other axis 104. The cells of these matrices were used to store attributes of the service elements ranging from the party responsible for the aligned service to the attributes and service levels for the service as well. The initial matrix could then be broken down further into related sub-matrices to show the more complex relationships of the attributes to the service and/or device/process components. Source of these concepts are illustrated in U.S. patent application Ser. No. 10/840,216, filed May 7, 2004, Publication No. 2004/0225549A1.

The above techniques model joint service supplier relationships for among other things the AT&T Solutions LAN service offerings. These services provided complex offerings of a life cycle of services delivered by multiple parties for a variety of technologies and geographies. The matrices are very useful for defining, communicating and coordinating complex services. The framework can be used to track, manage and optimize roles and responsibilities, costs, service levels.

### SUMMARY OF THE INVENTION

The present invention disclosed and claimed herein, in one aspect thereof, comprises a method for creating a relationship with an outsourcing client. A two way service relationship is simulated between two or more legal entities. This is facilitated by providing metrics that interrelate between the two or more legal entities, and then applying known service management principles to define an improvement in the simulated relationship between the two or more legal entities and as a function of the metrics.

### BRIEF DESCRIPTION OF THE DRAWINGS

For a more complete understanding of the present invention and the advantages thereof, reference is now made to the following description taken in conjunction with the accompanying Drawings in which:

FIG. 1 illustrates a prior art relationship matrix;

FIG. 2 illustrates an example of a training structure;

FIG. 3 illustrates an organizational hierarchy;

FIG. 4 illustrates a sequence of results for a given training program;

FIGS. 5 and 6 illustrate an example of net revenue for a single gaming session; and

FIG. 7 illustrates a resultant outsourcing relationship.

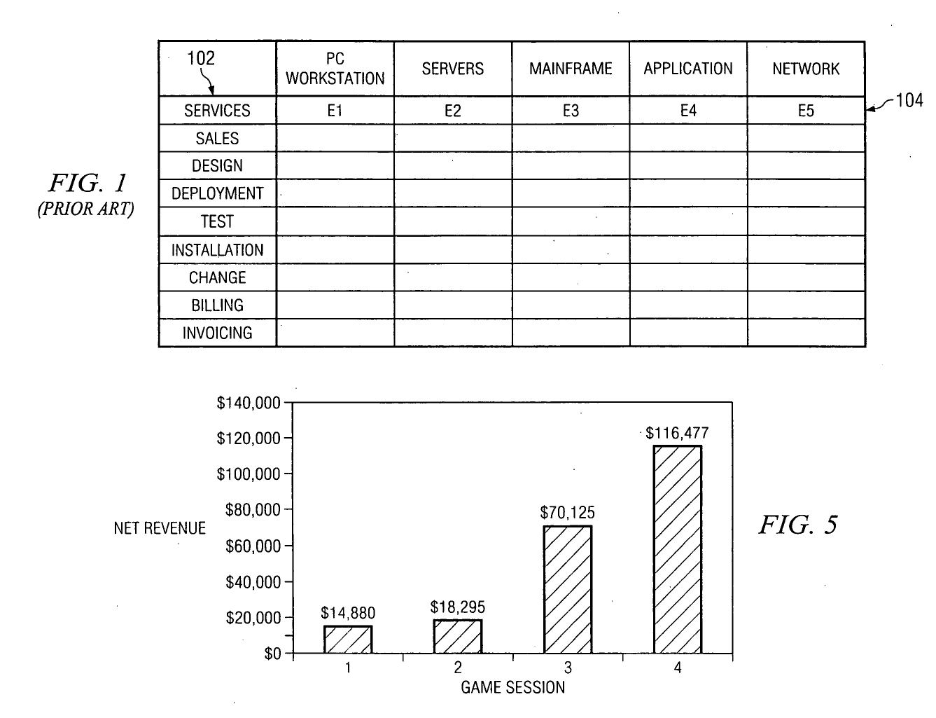

### DETAILED DESCRIPTION OF THE INVENTION

Referring now to the drawings, wherein like reference numbers are used herein to designate like elements throughout the various views, embodiments of the present invention are illustrated and described, and other possible embodiments of the present invention are described. The figures are not necessarily drawn to scale, and in some instances the drawings have been exaggerated and/or simplified in places for illustrative purposes only. One of ordinary skill in the art will appreciate the many possible applications and variations of the present invention based on the following examples of possible embodiments of the present invention.

In the disclosed sourcing method and system, the objective of the process is to highlight how groups can improve the sourcing life cycle by working better together through structured, measurable service management processes. This is in contrast to earlier systems which focused on the individual learning experience not the inter group dynamic of bottleneck recognition, resolution and improvement.

The scope of the sourcing method and process system includes but is not limited to: information Technology, accounting, insurance claims processing, business process outsourcing, retail bank call centers, mortgage processing. Each of these are examples of sourcing domains addressed by this business method and system. Process, project and task sourcing are also addressed by this disclosure.

In this sourcing business process and method the term sourcing is utilized to refer to any and all of the following sourcing structures: Traditional sourcing—one client and one sourcing provider; Co-sourcing—two sourcing providers working together with one client; Multi-sourcing—two or more sourcing service providers managed separately by the client; Alliance—multiple sourcing providers join together to serve one or more clients; Joint venture—one or more clients and one or more sourcing providers enter into a joint business venture or partnership; In-sourcing—where an internal client group is selected to provide sourcing services but is managed as a distinct entity.

Objectives of this business method and system are to improve the efficiency and effectiveness of all or part of the service sourcing life cycle to include the phases of pre agreement, service delivery and post agreement further described by but not limited to: activities leading to the establishment of a sourcing relationship; service design and delivery; the delivery, management and enhancement of sourced services; the transition of sourced services back to the client (or another party) at contract completion.

A simulated sourcing environment is set up (either in a computer program or board simulation) consisting of a series of functional groups, roles, business rules and objectives. During the simulation a facilitator introduces a variety of process and relationship bottlenecks and breakdowns. The teams work to resolve the bottlenecks and breakdowns by improving their processes and use of tools. The facilitator may introduce techniques, tools and process improvements to assist the teams in becoming more efficient and effective in achieving their respective and mutual goals. The simulation injects divergent business events such as supplier attempts to sell more service or resist service efficiencies due to profit motives as well as addressing services which may have been accidentally left out of requirements or contract negotiations.

The simulation is run in a series of rounds which allow the teams to benchmark themselves against previous performance and work through the life-cycle of a sourcing relationship. As the simulation progresses the participants will experience the improvements of the processes through their application of service management principles. The simulation facilitator will reinforce the improvements by framing their work in terms of service management processes and interrelationship of processes and organizations.

Performance of each team is tracked relative to service levels, cost, responsiveness and quality. A capability maturity model (CMM) based metric approach may be used to rate the team performance at various stages of the service delivery and simulation life-cycle. The CMM metrics can then provide an objective measurement to gauge the sourcing baselines, gaps, service improvements and results for each of the respective organizations. Models such as the ESCM model from Carnegie Mellon University can be used for both service providers and service users (clients) to show current status and improvements.

As an option, each of the sourcing teams (service providers and service users) may be assessed prior to the simulation and the results of the assessment may be used to choose the particular bottlenecks and breakdowns as well as the structure/path of the simulation.

As a game the Sourcing method and process provides an opportunity to practice and sharpen sourcing skills. For inexperienced participants the Sourcing method and process's clear steps provide a guide through the sourcing process. For more experienced practitioners the method allows the participant to graphically track the development of the sourcing life cycle through numerous rounds of process breakdowns and improvements.

One of the key features of the Sourcing method and process is that it can act as a decision support system. Before beginning or at any subsequent stage the actual sourcing participants must consider the importance of each decision option as well as the acceptability of each option. This forces the participants to define their preferences over issues and to consider what trade-offs may be required. The method also presents solution paths to frame the utility of the various combinations of options and overall utility of complete packages.

The Sourcing method and process can also act as a simulator to prepare for or improve a particular sourcing program. The method and system is designed so that when faced with an upcoming or existing sourcing initiative the participants can engage in mock sourcing processes to understand how the issues may emerge once the service delivery has begun in earnest. One could even use the Sourcing method and process to parallel an ongoing sourcing program. Sourcing process alternatives and actions could be entered to understand what progress, if any, is being made and what trade-offs are emerging.

The Sourcing method and process can also act as an Sourcing support system and support and facilitate real-life sourcing environments

Finally, the Sourcing method and process can provide a consistent training framework for one or more organizations. Through the Sourcing method and process participants can study and practice international sourcing practices involving people from diverse cultures to help understand how differing values and expectations may influence the negotiation process.

To deliver the simulation to potential participants in an outsourcing relationship, the following materials may be needed: a sourcing Pack that includes a detailed simulation materials list; Participants Instructions providing roles they will play in the simulation; The sourcing matrix with all of the sourcing elements detailed with respective attributes; Flip charts to provide discussion points during the simulation and four markers per chart (The flip charts are used during the introduction, to conduct reviews, and for participants to outline their plans at the beginning of each Session, and may also be used by the participants as incident and problem tracking boards); A large very visible clock or equivalent clock software; Pens, paper, calculators.

To prepare to deliver this simulation, the facilitator of the simulation should: Read and be familiar with all the materials for this simulation and the roles played in the simulation; Ensure each role has the information listed on each role instruction sheet.

The simulation is divided into multiple active learning Sessions. Each session consists of a period of planning, a round of the simulation followed by a session review.

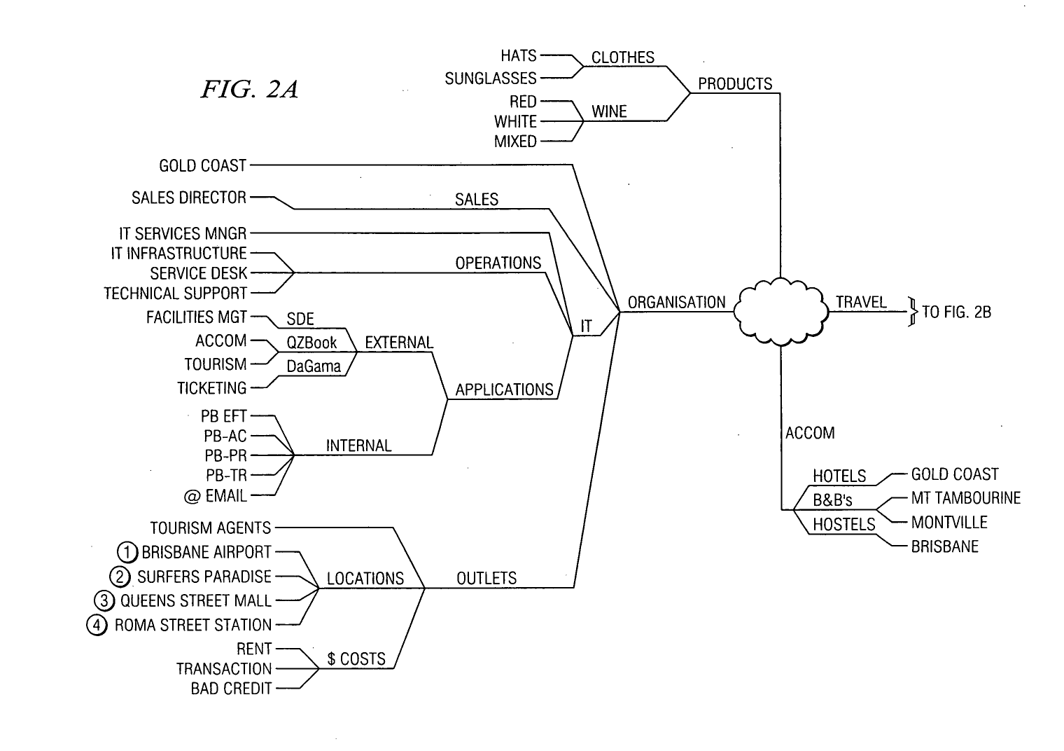

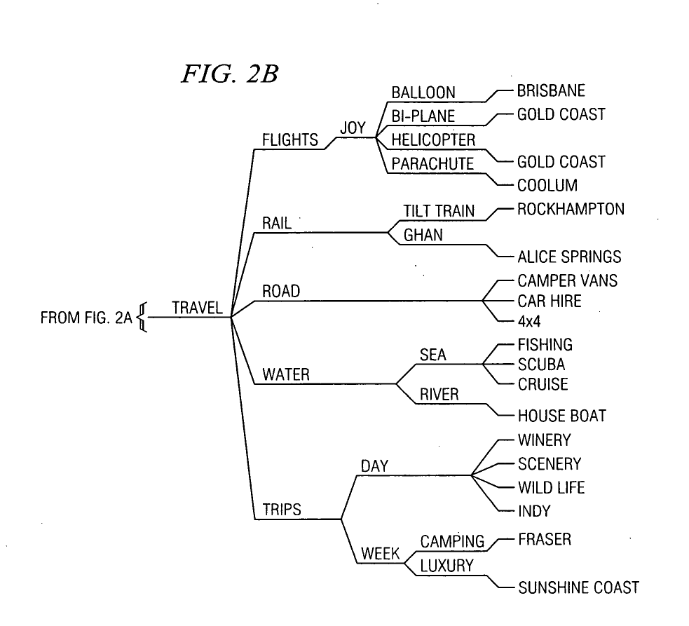

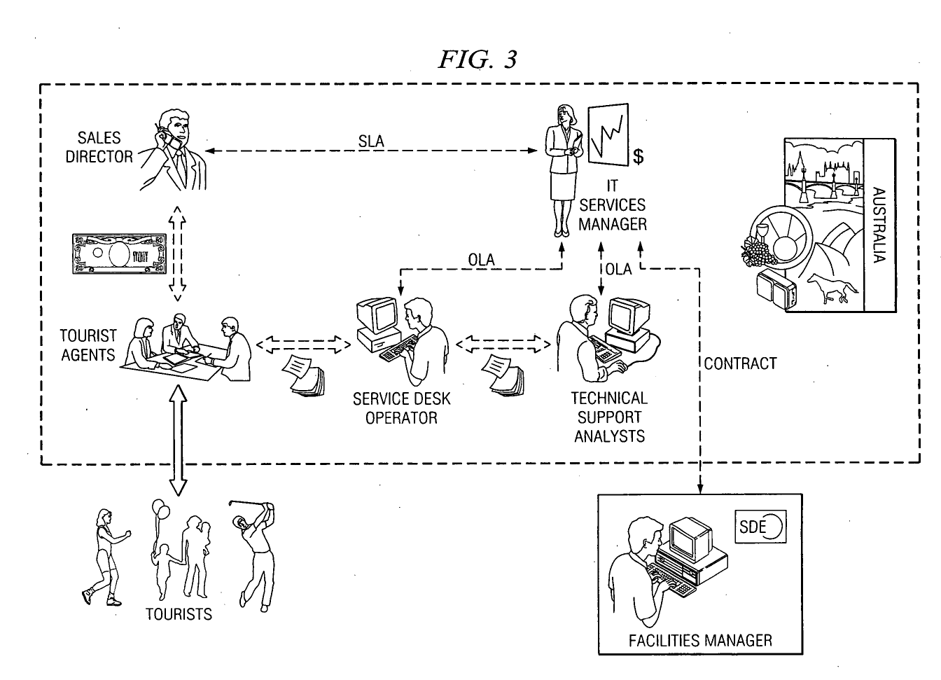

The simulation is designed to provide a series of activities, each of which highlights different elements of sourcing theory. On completion of each session of the simulation, a review is conducted. During this review the facilitator's goal is to support the participants in recognizing how their performance can be improved from a best practice process point of view, drawing out lessons learned. This active learning, combined with corresponding facilitator guidelines, will help provide a frame of reference to enable the participants to understand the sourcing optimization framework theory and practice. The facilitator should use a generic business example involving a generic business entity, such as a travel business, illustrated in FIG. 2, as a reference as much as possible throughout the theory lessons and discussions.

Example Simulation Sequence:

Day 1 Sourcing Management Introduction

Simulation Session 1

Session Review

Sourcing options and negotiations

Theory (Service Level Management)

Theory (Service Desk, Incident and Problem Management)

Day 2 Session 2

Planning

Simulation Session 2

Session Review

Theory (Configuration, Change and Release Management)

Sourcing Simulation Session 3

Planning

Simulation Session 3

Session Review

Theory (Financial Management)

Day 3 Theory (Availability Management)

Sourcing Simulation Session 4

Planning

Simulation Session 4

Session Review

Theory (Capacity and IT Service Continuity Management)

The sourcing structure is specifically designed to demonstrate the benefits to performance through the application of sourcing best practice processes. The simulation will display the key sourcing management processes and functions show their interaction. Over the multiple sessions, performance should show an eventual marked improvement, thereby demonstrating the benefits and impact of applying the sourcing framework.

There however will be times when due to the dynamics of the simulation and the skills and experience of the participants or the way the simulation has been run or interpreted, some sessions may show a decrease in the amount of financial gains in a session, the facilitator should still be able to draw this out to real world scenarios, such as too much money spent on workarounds, rather than use of local skills, or unjustified purchases of new technology, and then give some advice on how this can be improved in the next session.

To introduce the scenario of the generic business example, and the dynamics that exist between the various areas of operation, ensure that each participant has read the case study in their Manual. You could also either explain or read out loud the following section to the participants. The Sourcing Simulation provides services to customers. While there are numerous outlets for these services, for the purpose of the simulation, four busy outlets or business units provide services for a number of services and products. Each outlet is under the management of one of the participants taking on the role of an Agent who carries out the transactions, there being different types of Agents such as a travel agent, a travel agency business unit. The Agents are overseen by the Sourcing Simulation Sales Director, another role taken on by a participant, whose commission is tied to sales and therefore has a vested interest in the progress of sales.

The objective of the simulation is to service as many of the customers (they being virtual) as possible within a fixed period of time (30 minutes), generating revenue for both the Sourcing Simulation parent company (the generic business entity), Agents and Sales Director. Branch Infrastructure rental payment is made by the Agents for each session as well as payments for each transaction made. Each transaction earns a portion of the revenue for a Franchisee of the parent as well as a portion for the Sourcing Simulation Organization (generic business entity). The Sales Director has responsibility for the overall operations of Sourcing Simulation and is focused on maximizing profits, from which a commission is derived. High availability processes are required in order to meet this objective. Agents have responsibility for carrying out the customer transactions, checking the credit references for each client, and completing the necessary information and producing the Receipt. The key Sourcing Simulation processes are supported and maintained by a group of support specialists in respective roles, comprising of a Services Manager (SM), Service Desk Operators, (SDOs), and Technical Support Analysts, (TSAs). The SM is in charge of the SDO and TSA Teams. He/She has overall responsibility for maintaining the supporting IT Infrastructure and must meet the Service Level Agreements negotiated with the Sales Director. They also have to operate within strict budgets and may act in key ITSM roles, i.e. Change, Problem and Financial Manager.

The Service Desk Operators are responsible for logging and coding all incidents raised by the Agents. In this instance, their Customers (or Users) are the Agents. They are also responsible for providing user support for the business process, after Session 1. Technical Support Analysts have responsibility for maintaining and enhancing the underlying IT infrastructure that underpins the key business systems. They consist of a number of key individuals who have some training in IT Service Management Functions.

An external Facilities Manager, (FM), the representative of the outsourcer supplies the existing sourcing infrastructure to the Sourcing Simulation on a cost-per-session basis. They also facilitate two external services, DG service and OZ customer interfaces. In addition the FM can supply additional upgrades to the infrastructure, as well as temporary or permanent workarounds, equipment and consultancy services. The SM works closely with the FM to enable upgrades etc. The SM must determine changes required to the IT Infrastructure through consultation with the Technical Support Analysts, and ensure at all times to operate within financial constraints and understand that improvements to the infrastructure are required to also be cost effective.

Customer Agents: There are four outlets, all based within different geographic locations. Each Agent is provided with set of blank Booking Transaction sheets, and a set of customer cards, which are interspersed with Incident and STOP processing, card pairs, simulating the customers attending, (or phoning) the outlets, and the incidents which occur at each branch. Each customer must be served in the order of the card stack from the top. When an error incident card appears on the top, it is accompanied by a STOP Processing card, which indicates that processing of customers cannot continue until the incident is resolved. However the STOP card may not necessarily follow immediately after the Incident card depending on the impact level of the incident. (i.e. sometimes another customer may be able to be serviced, before the processing is stopped). Agents are also provided with an Agents Services and Products Catalogue and a Credit Authentication check list.

For each Transaction, the Agent is required to look up the booking code in a pricing catalogue to obtain the latest price. They should write the details on the Booking Transaction sheets as they progress, because they are required to total the transaction at the end of the session. They then need to check the credit authorization and check that enough funds exist in the nominated account. If there are enough funds they need to look up and insert the credit authorization code. If not enough funds exist then that transaction should be abandoned. Financial fees of $100, for example, are paid for processing a transaction that does not have enough funds allocated. They should then retrieve a Ticket/Receipt based on the Authorization code and complete the remainder of the transaction including the funds apportionment and ticket number details which are found on the tickets. This completes the transaction. When an incident card is presented it would need to be resolved via the Service Desk. The Incident card must remain with the Agent, the details of which are taken by the service desk onto a Post-It note, representing a phone call. The Service Desk will remove the STOP card once the incident has been resolved in some way or other. The incident cards each contain a Major/Minor style error code as well as a Level indicating the severity of the incident to the Agent. Once the STOP card is turned up, no further work can continue at all at the outlet until the incident has been resolved completely.

In addition, there will be incidents and other events such as changes, extra incident, or special activities that the Facilitator will raise by putting down specific alert cards with the Service Desk, Services Manager or Customer Agent that will need to be resolved, or downtime planned, sometimes before any processing can continue.

Throughout the session the Sales Director will be interested in Agents progress to gauge whether sales targets are being met. The Agent would be interested in keeping track of how much downtime is being experienced using a watch, stopwatch or the clock on the screen.

At the end of each session, each Agent should total the income. They should then complete their financial statement for that session, which also includes incident statistics, downtime, and net worth for the session for that site for both the Agent as well as Sourcing Simulations share.

Customer Service Desk: At the Service Desk the call is logged, indicating that an incident has occurred, by the Agent providing the Service Desk Operator (SDO) with the details on the Incident cards. The Service Desk Operators need to use the Sourcing Simulation Impact Analysis and Incident Decoding Guide to identify the potential source of failure based on the error codes. Error codes have a Minor/Major code component. This information would be transcribed to a paper note which is basically the Incident Ticket.

For example if the error code is E060/E100-xxxxxx then, according to the guide, it is an Application type error which has interrupted the PB-TR service. This information is then recorded on an Incident ticket. (paper note). While there are no explicit instructions provided, other than this, it is expected that the operators will also need to Number the Incident, as well as record the time of the incident based on the time assigned to that transaction in the Agent Booking sheets, as well the Branch name or number. However deciding what information should be supplied is all part of the learning curve for the SDOs. This information, written on a paper note, is passed onto the Technical Support Analysts. Further point of interest is to note how the SDOs record the information for themselves, whether they make a copy, or write it up on a log and manage the escalation and monitoring.

The Service Desk is also the primary interface with the Facilitator, as well as providing business support to the Agents.

Technical Support Analysts: The support team has diagrams of the IT Infrastructure Real World configuration, which shows what is actually installed. This shows the details of all IT hardware and software used in the IT Services centre as well as the Network and Branch layouts. During the game they may change or add extra components to the Configuration Diagram by drawing on the laminated surface with the supplied non permanent pens.

Note: All changes will be required to have gone through a change process which may include some outage time. In addition they have a Configuration Management Database (CMDB) Asset and Problem Resolution listing which lists the documented, as opposed to the Real World view. This listing includes questions against each Configuration Item (CI), for each of the game sessions. These are the questions that are required to be solved when a problem is found with the CI. There are a few minor but deliberate errors in the asset listing. These are used to bring out the importance of the Auditing element of Configuration Management, and may lead to some confusion when searching for problem resolution questions. It should be observed if they audit and verify the CMDB listing. An updated copy can also be purchased from the Out source Facilities Manager. Using the configuration diagram, asset listings and the information passed from the Service Desk, the potential failure points can be ascertained.

For example: Application/PB-TR (PB-TR being a generic service with a name recognized by the participants) would indicate an issue with the PB-TR service for that Agent, and indicates which service has been interrupted. The configuration diagram, and some common sense, will show that there are a two potential failure points, the Client CL-PB-TR-xx, or the APP-PB-TR Application, while is also possible the Server, the Network Bridges could cause the service to fail, the fact that it is an Application error, narrows it down. More information may be required from the Service Desk to locate the exact point of failure such as how many Agents are affected. i.e. if all four Agents suffer from the same type of incident at the same time, it probably indicates a problem with the Application itself, rather than the Clients.

ITIL (IT infrastructure library) learning based questions, which need to be answered correctly, are used to simulate the investigation required in resolving the incidents and problems. Therefore, once the location of the incident/problem is identified, the Asset and problem Resolution listing is used to look up a question number assigned for that component. The question is identified depending on the Game Session Number being played. The System Support Manual is then referred to and the relevant ITIL question is looked up and answered.

The answer is passed back to the Service Desk, who is required to check with the Facilitator if the answer is correct. If it is correct, the Facilitator authorizes them to remove the STOP card from the pile, and the Agent can continue, provided other outstanding incidents do not exist which may still prevent resumption of processing.

It should be explained to the participants that, if an incident affects less than four Agents, this would indicate an issue with the Clients rather than the Application. Therefore the time on the Incident cards is vital for showing this relationship. A Known Error Data Base (KED/B) is also provided for the Technical Support Analysts to use. This contains reference material relating to incidents supposedly previously resolved in the form of answers to questions. Not all of these answers are related to questions which will arise during the game, but it does give an idea of what should be done. In most cases the participants ignore the KED/B when the simulation is under way. As the Sessions progress, the Technical Support Analysts should be compiling their own additions to this D/B in order to identify and resolve recurring problems. For the sake of the simulation dynamic, it is important that the D/B is not brought to the attention of the participants. This is to allow them to find it for themselves, thereby learning the importance of having and managing a Known Error data base.

Sales Director: The Sales Director (SD) takes overall responsibility for the running of the Agents and is primarily focused on maximizing revenue and reaching financial targets. The SD has direct line responsibility for the Agents, as well as for agreeing a Service Level Agreement (SLA) with the IT Services Manager. The SLA needs to be met in order for the organization to meet its objectives. This should be stressed as it provides a measure for performance, as well as a very entertaining dynamic once the simulation is underway. The Director will need to constantly update the situation and total the income to see if targets are being met. The will also be required to produce a financial statement for each round.

IT Services Manager: The IT Services Manager (SM), is in charge of the Service Desk and Technical Support teams and is responsible for maintaining the high availability of systems, within the budgetary restraints. It is important to stress that they take overall responsibility for the availability of the IT Infrastructure and Customer Service and that the Business Director demand a high level of service. Therefore they will also need to maintain a financial statement which will include budgetary information. This adds a lot of value to the simulation by providing the customer with real business issues and priorities. The interaction between the SD and the SM is key to the simulation dynamic. The success or otherwise of their relationship is crucial, and it is possible that blame for failure to meet targets will pass from one person to the other. One of the objectives of the simulation is to have fun, and much of this will be provided by the interactions and dynamics between participants which contributes to the enjoyment of the simulation. The role of the facilitator is therefore key to developing interactions as well as highlighting, where necessary, the cause and effect of the different sorts of relationship that may be evident.

Facilities Manager: Sourcing Simulation out source their IT Infrastructure to SDE (Super Delivery Enterprises). The SDE Facilities Manager (FM) supplies IT equipment and consultancy to Sourcing Simulation organization at a cost. If there are not enough participants, this role can be played by the Facilitator. Session costs for the IT Infrastructure are fixed and these cannot be negotiated. The FM has a wide array of additional equipment for purchase. All the information is available in the SDE Technology Catalogue, complete with costs, and matching cards which are handed out at the time of sale. The FM can also provide temporary workarounds or permanent solutions, equipment and consultancy. All must be paid for. The FM provides the SM with an Invoice at the end of each session, which needs to be completed and totaled to gain the true nature of the financial situation for each session. Some of the costs will be static for each session, but the others will depend on the FMs ability to sell services and solutions, and the SMs ability to make use of all resources available to provide the IT services.

Participants: The simulation will have to be structured depending on the number of participants on the course. Sourcing Simulation has been developed to work with a minimum of eight and a maximum of sixteen players. It should be noted that while the simulation may be scaled down to eight players, a more effective dynamic is achieved with 12 or more players A table below shows which roles should be filled, depending on the number of participants.

The Facilitator must stress the importance of reporting all incidents, for example the Agent must report that there has been a failure with any function. Failure to report all incidents could result in the misidentification of the point of failure and, subsequently, the wrong question will be answered and the incident will not be resolved. Prior to the start of Session 1 the facilitator should allocate positions and roles to the participants, depending on the numbers (use the table above for reference). This can be done either by asking for volunteers for the positions or by nominating them directly. The basis of this will depend on the skills and abilities of the participants. It can be an interesting dynamic to nominate a technical person in a business role and vice versa.

Note: It is recommended that when allocating positions that remain where they are sitting until all positions are allocated. Only then ask everyone to move to their respective positions. This prevents confusion at the time, especially as they will all be feeling out of their comfort zone at the start of session 1. For 15+ participants, Observers can be appointed to prevent over crowding in the game. They could perhaps be asked to comment and make notes on the positive and negative aspects of how the participants are performing in the simulation or as a Technical Observation Post arrangement to improve processes, and which can be used as a reference back to Availability Management ensure that observers are switched around otherwise they can feel alienated from the exercise. Should only be used for contingencies

Role Changes: Over the four Sessions of the simulation, the facilitator should aim to rotate the participants around the different roles. This is so that they can experience the simulation from different perspectives. Some positions, if they are working well may be retained throughout the game such as the Managers and Director, but the Facilitator should use this as another tool to manipulate the outcomes, or ensure the game success when initial combinations may not be working well.

At least one Agent from the 1st session should swap to a Service Desk Role after session 1. This allows the Agents business skills to be transferred to the Service Desk, and allows the Service Desk to become a business focused Service Desk, that can assist Agents with the business process. The facilitator should try and enforce this attitude by sending queries from Agents about business process to the Service Desk. The senior management positions especially, are key to the success of the game, so it is best to change these positions if it is found that the initial participants are finding difficulties immersing themselves in these roles. Also some people may tend to prefer to remain as Agents, especially if they are non-technical. It may be a good idea to ensure they do take on other roles such as the Service Desk, to ensure they have a good learning experience overall.

The SDE Facilities Manager should also be monitored. If they do not take on this role play in an aggressive way, (i.e. they should also be profit focused), then encourage and mentor this role. This is also a role that may need to be changed to prevent non-involvement and ensure a good learning experience.

Controlling the Simulation: The Facilitator works from a different Session Master sheet for each of the sessions. Each Master sheet contains three tables. The standard Incident running order showing the thirteen time slots, the errors and Questions numbers, as well as a column to mark in order to indicate whether or not temporary or permanent workarounds were used.

A list of extra incidents to be used at the shown times to manipulate or slow down the session to get the required outcomes. This would be used as the facilitator sees fit.

A list of Special Activities such as Changes, (RFCs), or Virus attack that are required to be presented to the Technical Support team, and which have to be addressed accordingly. While there is a need for these to be presented from a learning perspective, once again the facilitator has some discretion about these based on circumstances at the time.

The Questions & Answers list: Prior to each Session the facilitator is required to sort and stack the customer cards, (thirteen each), for each Agent in time order and intersperse the Incident Cards and STOP for that Session, also in time order, in the stacks. (Each Incident card should be accompanied by a Red STOP Processing card which should be inserted directly below the incident card for Level 1 & 2 incidents and one customer later for Level 3 incidents). These should then be placed in the Business Card Holders at each appropriate Agent with a blank card on the top in readiness to start the game.

The facilitator will instruct that the Incident cards are removed from the Agent's stacks once the question to resolve the incident/problem had been answered correctly. Alternatively if the support teams decide to buy and utilize a temporary workaround from the SDE FM, then the Incident Blank card should be re-inserted one customer later, in order to allow processing to continue for one more customer before it re-appears.

Note: only one temporary workaround may be purchased per Incident. If a permanent solution is purchased or the Incident resolved, the STOP card should be removed by the Service Desk from the Agents stacks to allow processing to continue. Permanent solutions apply to the Problem/Error, therefore if it is one error affecting all four agents, (this can be determined by the nature and timing of the incidents), the solution will enable all four of the matching Incidents to be cleared. The facilitator will have a set of extra, (yellow), incident cards that can be handed directly to the Service Desk as and when they are required. They are used at the discretion of the facilitator to help ensure that each session objectives are achieved and will be of a generic type of nature, often requiring a stand down on all Agents until the problems has been cleared. The facilitator will also have a set of Special Activities cards such as Changes, (RFCs), (green), or Virus attack, (pink), that are required to be presented to Technical Support, Services Manager or Agents, and which have to be addressed accordingly. There is a need for these to be presented from a learning perspective, however the facilitator has some discretion about these based on circumstances at the time.

For each Session, the coinciding Master sheet should be used. The Facilitator should indicate when the Question is answered or Temp or Permanent Workarounds are used. Note: that some of the special activities could be made invalid by the roles purchasing redundancy, or preventative equipment or S/W and the facilitator need to take note of this and ensure any special activity made invalid is not used. These points should also be drawn out during the Session reviews. (E.g. If Virus S/W was purchased and implemented before the Change to implement Virus S/W, or a UPS is purchased that would avert the power failure consequences etc) At certain points throughout the Sessions an incident may occur which will stop all processing, effectively closing the Outlets. When this happens the Sourcing Simulation Product Catalogues should be taken from the Agents so that they cannot continue working. These can only be returned when the incident is resolved. The reason for removing them is so that they do not continue to complete the transactions in the event that they are unable to work. Other devices can also be used to add a flavor of realism such as turning off the lights etc. When correct answers are returned via the Service Desk the Catalogues can be returned to the Agents so that they can continue.

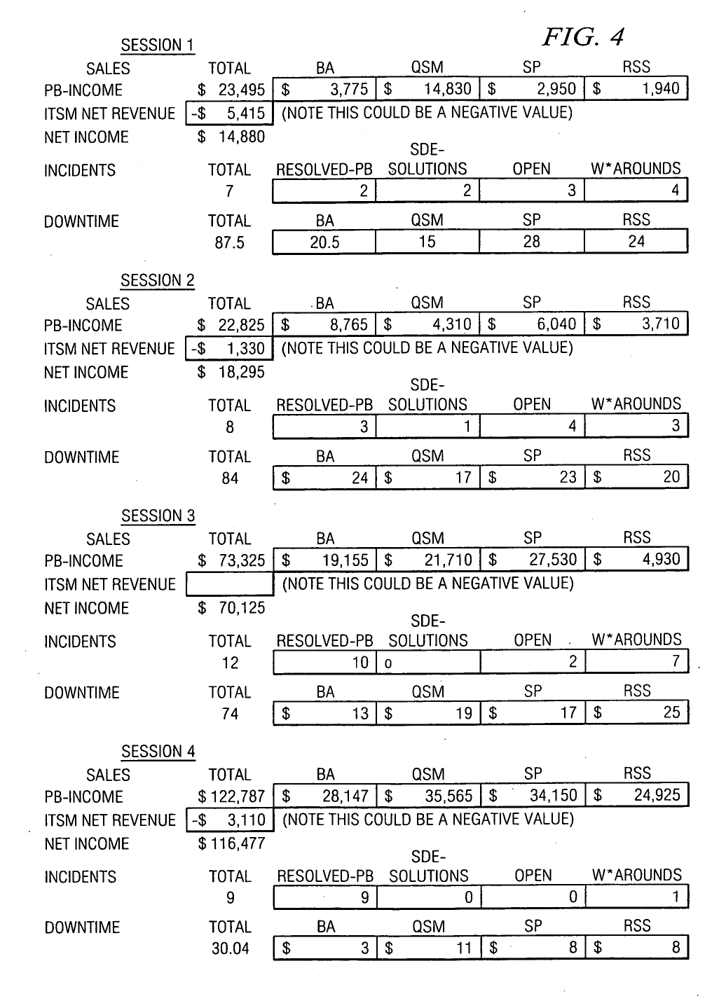

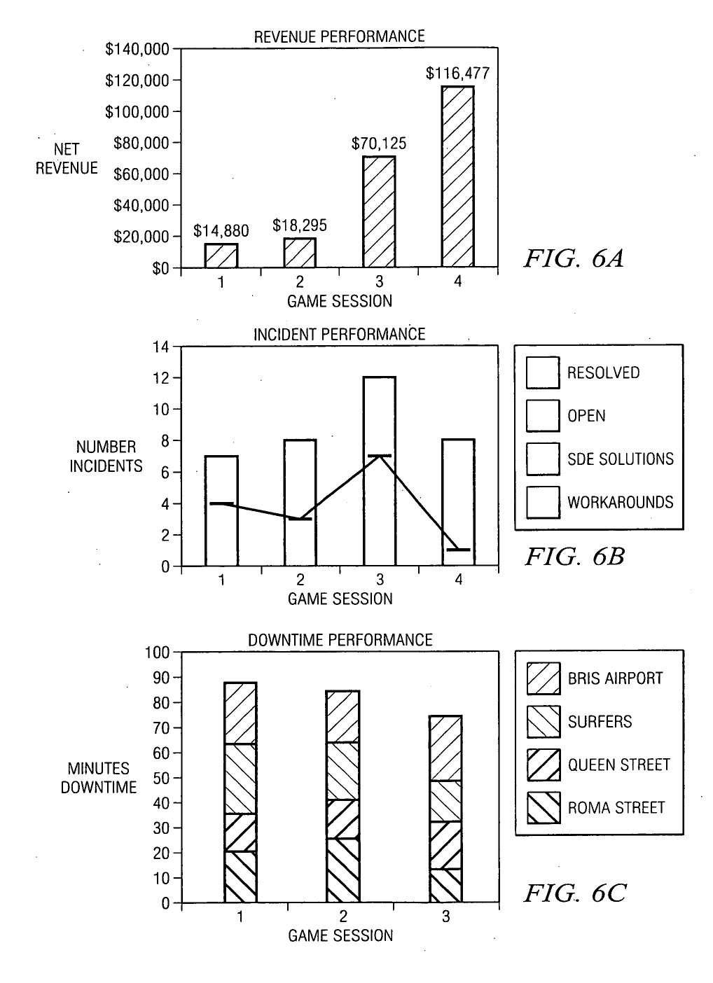

At the end of the session, all unused Ticket/Receipts should be removed and the monetary values totaled, and a financial statement calculated and completed. The SD Manager would complete his Profit and Loss Statement from the financial statements from the Agents and Services Manager to calculate the revenue at the end of each Session. The completed Booking sheets should also be collected in order that to prevent them being copied at the next session. A graphical display of revenue earned and Incident statistics is shown by the facilitator utilizing an Excel spreadsheet, and PowerPoint presentation. An example of an Excel spreadsheet is illustrated in FIG. 4 and an example of the corresponding PowerPoint presentation is illustrated in FIG. 5 and FIG. 6.

To demonstrate how lack of Customer focus and process, poor communication, and/or poor service management can lead to chaos in IT and business operations, significantly impacting business performance.

Prior to the start of Session 1, the Session 1 Customer/Incident stacks are issued in the holders. The facilitator provides the participants time to read the instructions and use this time to move between the groups reinforcing the details from the introduction, such as participant roles. He ensures the Agents are aware of how to process customers, as this is not the bad processes being highlighted, and too much confusion here could cause ill feelings towards the training itself. There is a process flow diagram on the back of each Credit Authorization laminate. Explaining to the Support people how to find the Questions with which to fix the problems is also important. Explain in particular that the Incident indicates which service is being interrupted which does not necessarily indicate where the error lies, the error type is needed to help diagnose the suspect CI. He also makes it clear that the timings on the incident cards themselves are important. The participants' poor familiarity with their roles and lack of process usually leads to poor incident resolution, which in turn impacts on the business performance. Agents will usually grind to a halt and chaos will reign supreme. The Session starts with the clock/timer being reset and the top card removed from the Customer stacks.

The first 30-minute Session can proceed when all the above has been completed. Common Issues that will arise from Session 1 include: Confusion as to exactly what the processes are. No time stamp included on the ticket, no priority assigned to the ticket, number of Agents impacted or assigned to Incidents. Miscommunication between Agents and Service Desk resulting in wrongly coded Incidents. Miscommunication between Service Desk and Technical Support resulting in delays in resolution. Time delays in resolution resulting from the SM's reluctance to purchase additional hardware or services. Assumptions made which result in mis-diagnosis of issues, leading to delays in resolution. Lots of noise

At the end of the Session, all Transactions are logged and a Net Worth value calculated. In addition, counting how many Incidents were raised, how many resolved, how many workarounds or solutions were used, how long each Agent had in downtime, etc. are also logged. In the first Session it is doubtful the Service desk would have kept these types of statistics, which can be drawn out as a learning outcome.

Review: The Facilitator should lead the review session to assess the outcomes and draw out the learning from the Session. This will be achieved by focusing the participants' attention on specific areas by asking them to consider a number of questions: How successful were you? What worked? What went wrong? How effective was the Incident Management processes? What Problem Management was in place? How well did the Service Desk function? What Incident statistics were kept by the Service Desk? Were financial targets met? What were the downtime statistics? Should an SLA be established? Should OLAs be established ?

In Session 2, at least one Agent is swapped into the Service Desk, and other roles change are made as required. This activity should follow the review from Session 1 and the preceding ITIL theory lesson. The activity begins with the participants planning improvements for the next Session. The participants will take 10-15 minutes to plan the changes before presenting their plans back to the Facilitator using the flip chart. Key points to reaffirm to the group are the processes of: Service level Management, Service Desk, Incident Management and Problem Management and you may suggest some type of process walkthrough. A model SLA and OLA for Sourcing Simulation would have been provided as part of the training and the facilitator should point this out, as it should form the basis of deciding Incident priorities etc. In addition a process flow will also have been handed out for the support processes, which should help improve process in this session. The facilitator may to show the ppt presentation of the previous session outcomes. Allowing the Sales Director to give a brief motivation talk and specifying targets for the upcoming session can also be a good dynamic at this point.

Prior to the start of Session 2, the Session 2 Customer/Incident stacks are issued and anyone who was an Agent in the previous Session should be given a different site. This can be achieved by moving the Agent equipment to the alternative table, because the participants are sometimes reluctant to change.

Session 2 should see changes to the process used by the participants and these may improve performance. Ideally, an improvement should be realized as a result of better communication, process, service desk, and incident and problem management. The Facilitator should pay particular attention to the areas where the group has planned to implement changes to the way they work and note any improvements in performance.

The Session starts with the clock/timer being reset and the top card removed from the Customer stacks. During this session an Emergency RFC is issued to install Virus S/W is provided. This change is time critical and mandatory. If not completed within 5 minutes, then the Virus Attack is introduced to the Technical Support team who need to resolve the issue by answering a Question. The change applies to Application APP_EFT, as well as the Client interface and affects this critical application. Before the change takes place, the Technical Analysts must notify the Facilitator. This change will impact on the Agent's ability to perform and is designed to highlight the requirement for effective Change, Configuration and Release Management. If they are unable to complete this change then it should be held over for the next session.

The Facilitator should allow the sales Director to lead a review of the business outcomes and then review the session to assess outcomes and draw out the learning. The Facilitator should reference where any purchases made and implemented in the game may have averted any of the Special Incident activities being used, and point out their good planning averted the incidents and possible outages. How successful were you? What worked? What went wrong? How effective was the Incident Management? What Problem Management was in place? How effective was it? How well did the Service Desk function? How well did the Emergency Change go? Were financial targets met? What were the downtime statistics? What were the incident statistics? Was the SLA met? Do they need to appoint an Incident Manager or Problem Manager?

Purpose: To allow the participants to apply the further lessons learnt during the preceding ITIL training lesson in an attempt to improve performance.

Make roles changes as required. Planning commences on completion of the second lesson discussing the Configuration, Change and Release Management elements of the ITIL Framework. The participants should have identified areas for improvement in their performance during the Session 2 Review. In addition, further ITIL theory will have been covered and should have introduced additional processes, thereby directing the participants to further improvements in their procedures and process. The Facilitator should ensure that the ITIL processes highlighted in the previous sessions are reinforced. In addition a process flow will also have been handed out for the Change processes, which should help improve process in this session. The facilitator may to show the ppt presentation of the previous session outcomes.

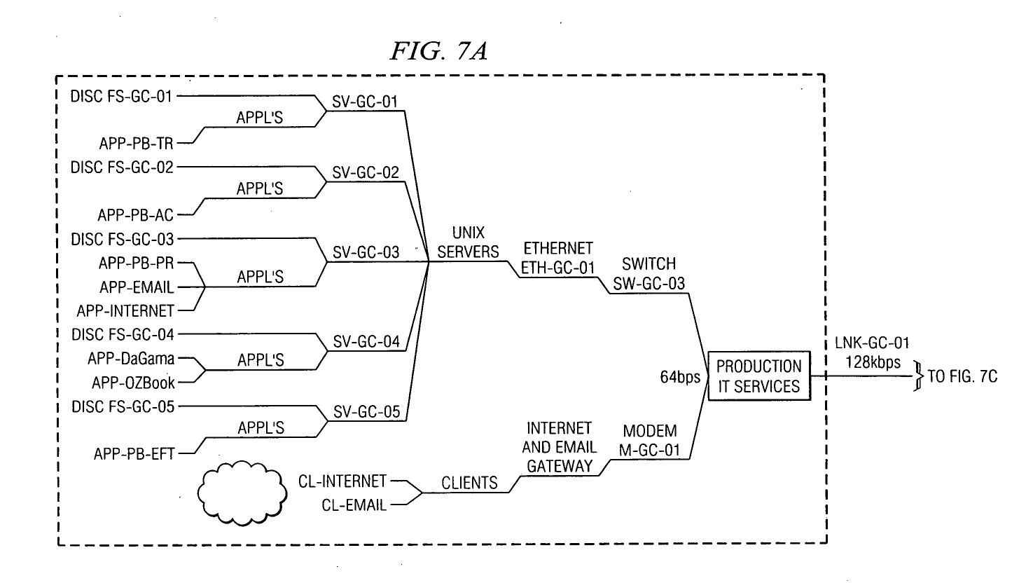

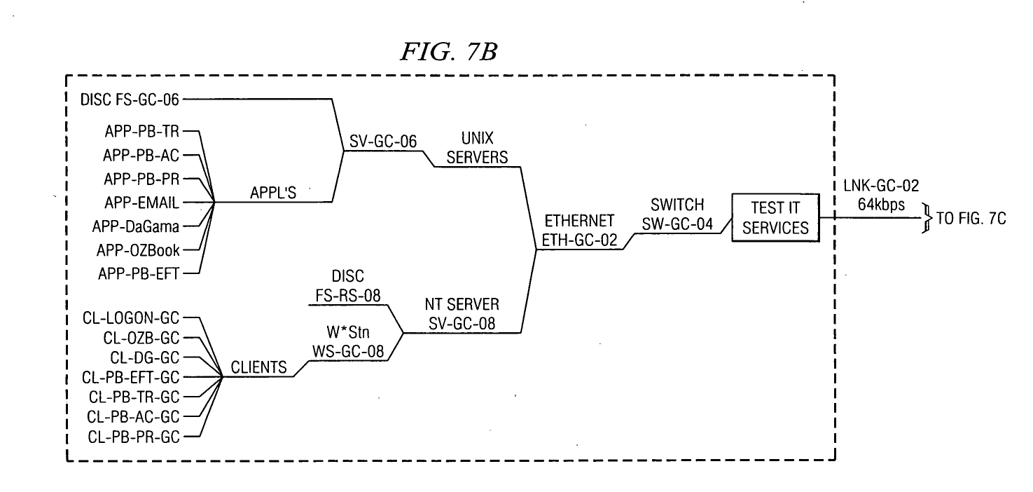

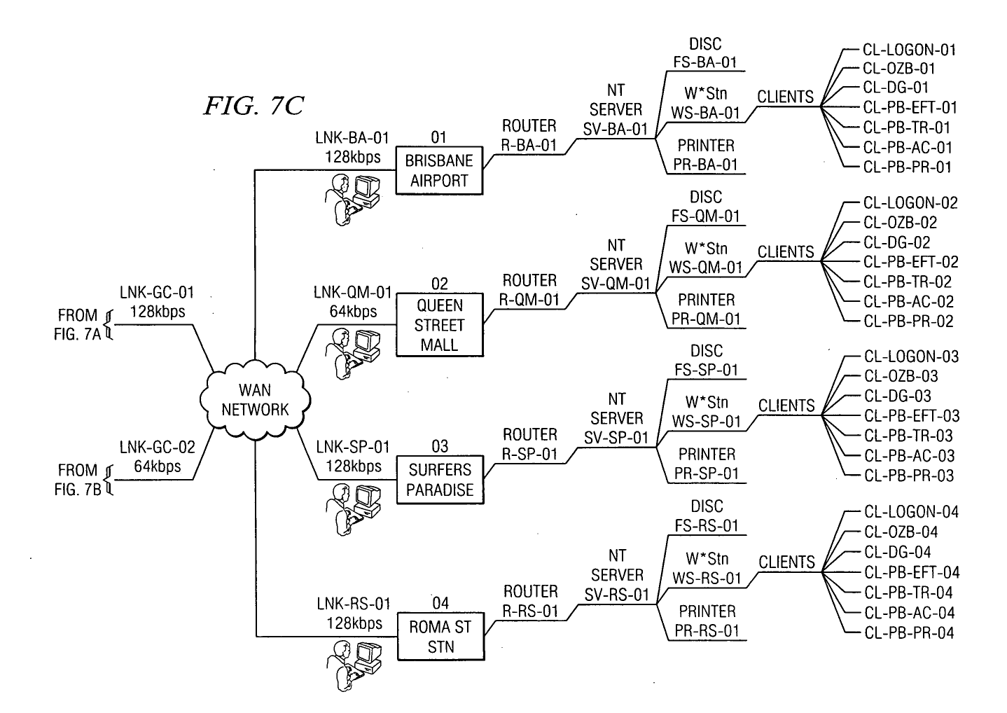

Prior to the start of Session 3, the Session 3 customer/Incident cards are issued and anyone who was an Agent in the previous Sessions should be given a different site. The Session starts with the clock/timer being reset and the top card removed from the Customer stacks. An RFC is introduced to upgrade the EFT Application. Before the change takes place, the Technical Analysts must notify the Facilitator. This change will impact on the Agent's ability to perform and once again is designed to highlight the requirement for effective Change, Configuration and Release Management. In addition if the change was not carried out within ten minutes, or if the Facilitator wished to slow the game down there is a 2nd activity which is a Change failure, requiring a regression of the change, downtime etc. A network failure is introduced affecting all services and also to highlight that there is a mismatch between the CMDB listing and the Real World. If they have not audited the CMDB and found this out prior to this point they can buy a service from DSE to do the audit and produce an updated CMDB listing with the changes highlighted. A Power failure is also introduced at the location of a particular Agent during this session, and the technical team will need to answer a Question to restore normal operation. (See FIG. 7 for example). This Session should see improvement in all processes and also communication, Change, Configuration and Release Management.

The Facilitator should allow the sales Director to lead a review of the business outcomes and then review the session to assess outcomes and draw out the learning. The Facilitator should reference where any purchases made and implemented in the game may have averted any of the Special Incident activities being used, and point out their good planning averted the incidents and possible outages. How successful were you? What worked? What went wrong? How effective was Change Management in response to the change? How effective was the Release Management? Did the Change fail? What Problem Management was in place? How effective was it? How well did the Service Desk function? What were the Incident statistics? Was the error on the CMDB listing discovered, and explain how this highlights the need to verify and audit the CMDB to the Real World. (i.e. the switch SW-GC-03 was still known as SW-GC-01 in the CMDB listing) Were financial targets met? What were the downtime statistics? Was the SLA met? Do they need to appoint a Process Managers? How could the reliability of the IT Infrastructure be improved?

Purpose: To demonstrate the effectiveness of the Service Delivery processes in providing high availability systems. This will be achieved by focusing the participants attention on these areas and, specifically, how they can apply what they have learnt in the previous theory session. The purpose of this session is for the group to look into improving the infrastructure especially from an Availability and Financial Management viewpoint, looking at adding resilience into the system especially looking at the offerings from the Facility Manager in terms of upgrades to add resilience and minimizing risk, as well as the cost implications thereof.

Make roles changes as required. The participants should have looked at the prior example discussed during the training and be planning to look into improving resilience. The Facilitator should emphasize that the purpose of this exercise is to look at the more proactive approach to managing the infrastructure, and prevention of downtime and designing for quick recovery and risk minimization. The Facilitator asks the group to prepare for Session 4 by giving them time to plan how they can apply the learning from the previous Review and previous theory Lesson. Some expectations would be to improve financially with fewer workarounds and solutions purchased and more resolved by PB analysts. The facilitator must also ensure they are aware of any Infrastructure purchased which may prevent certain of the extra incidents such as power outages and network failures being averted and therefore the facilitator cannot use them. The facilitator may to show the ppt presentation of the previous session outcomes.

Prior to the start of Session 4, the Session 4 Customer/Incident cards are issued and anyone who was an Agent in the previous Session should be given a different site. During Sessions 4 the Facilitator should manage the extra incidents in such a way as to ensure that the final session shows a marked improvement on Session 1. Extra incidents can be used during this session. The incidents in this session will relate to Availability and Capacity type issues. A Network failure is also introduced during this session, and the Technical team will need to answer a Question to restore normal operation. However cannot be used if redundancy was purchased and implemented. An RFC is issued to the Technical Support team by the Facilitator for implementation. This change is time critical and mandatory. The change applies to adding resilience in the form of a Raid5 disc Array to a server. Before the change takes place, the Technical Analysts must notify the Facilitator. This change will impact on the Agents ability to perform certain functions. It is designed to show what changes may be required to improve availability aspects to the infrastructure, and follows a set of media errors on the normal ticketing errors.

The review should briefly focus on overall performance including financial targets and SLA achievement. The review should also focus on what incidents were averted by purchasing redundancy, resilience and UPS's, etc.

Summary: Over the whole simulation, there needs to be a steady improvement in performance throughout. It is important that this is the case because it will help to reinforce the learning and to make it more enjoyable for the participants. Without looking like being too contrived, the Facilitator should consider adding or removing incidents at their discretion to maintain this progression. Adding or removing incidents will have the effect of making the simulation more difficult or easier depending on the outcome required. It is important that the group participating in the simulation do not over-achieve prematurely for example in Sessions Two or Three. Equally, if they are performing poorly or not improving from Session to Session, this is not desirable either. Final Review Input During the final Review of the Service Management Essentials course, it is important to reinforce the course learning by relating the simulation to the course as a whole. One way of doing this is to remind the participants how their performance has improved over the four Sessions visually with the graph, which plots the financial and incident statistical aspects of the simulation. This improvement can be related to the application of ITIL best Practice to the simulation from the lessons they have learnt and these have clearly had an impact on the business bottom line.

1. A method for creating a relationship with an outsourcing client, comprising the steps of:
simulating a two way service relationship between two or more legal entities;
providing metrics that interrelate between the two or more legal entities; and
applying known service management principles to define an improvement in the simulated relationship between the two or more legal entities and as a function of the metrics.

2. The method of claim 1, wherein the metrics define the manner by which any of the two or more legal entities interrelates in a service relationship with any of the other of the two or more legal entities.

3. The method of claim 2, wherein there are at least three legal entities.

4. The method of claim 3, wherein the metrics for each of the legal entities represent the relationship between each of the legal entities and one of the other of the legal entities and the service relationship between one of the legal entities and another one and the step of applying defines the service relationship between one and another of the legal entities takes into account the metrics between the another one of the legal entities and the third one thereof.
